(19) United States
(12) Patent Application Publication
(10) Pub. No.: US 2015/0134943 A1
(43) Pub. Date: May 14, 2015

(54) SYSTEM AND A METHOD OF BUILDING A PRIMARY SYSTEM

(71) Applicant: INDUSTRIAL TECHNOLOGY RESEARCH INSTITUTE, HsinChu (TW)

(72) Inventors: Chen-Yu LEE, Taipei City (TW); Chia-Chen LIU, Changhua County (TW); Yen-Hsueh CHEN, Hsinchu County (TW)

(73) Assignee: INDUSTRIAL TECHNOLOGY RESEARCH INSTITUTE, HsinChu (TW)

(21) Appl. No.: 14/132,218

(22) Filed: Dec. 18, 2013

(30) Foreign Application Priority Data
Nov. 8, 2013 (TW) 102140730

(51) Int. Cl. G06F 9/44

(52) U.S. Cl. CPC G06F 9/4406
USPC 713/2

(57) ABSTRACT

According to one exemplary embodiment, a system of building a primary environment may comprises an external storage module and a smart device. The external storage module stores multiple digital data. Data transmission for the multiple digital data is provided between the external storage module and the smart device. The multiple digital data at least includes external data of an operation system (OS)/Application OS (AppOS), and resident data of the OS/AppOS. After the smart device starts up, at least one first loader of the storage module is duplicated as a second loader of the smart device. The second loader loads the external data and the resident data respectively to integrate as an AppOS image file, and activates the image file to launch an AppOS environment.

### CROSS-REFERENCE TO RELATED APPLICATION

The present application is based on, and claims priority from, Taiwan Patent Application No. 102140730, filed Nov. 8, 2013, the disclosure of which is hereby incorporated by reference herein in its entirety.

### TECHNICAL FIELD

The disclosure generally relates to a system and a method of building a primary system.

### BACKGROUND

In recent years, combining networks and display terminal devices becomes common, and digital content industry highly flourishes. Digital content services have become one of the main streams of the future business model. Digital content spreads sharing through open networks or community platforms. Digital commercial market mechanism uses digital right management technology to protect the intellectual property right of digital contents. The platform architecture of constructing digital rights may contain layers of management, building authentication protection mechanism, and implementing digital right system, from the consumers, the terminal devices, digital content providers, digital content distributers, etc.

Currently applications installed on a smart device may widely appear in the application market, and many of them may directly provide users watching applications of digital contents on the smart device. Digital content providers or digital content manufacturers facing protective measures and additional costs management of information security will become one of the important issues of enterprise information security. For example, lightweight device (e.g., mobile device) shares information on the cloud may increase risks of betraying confidential information, or protection measures of information security on related issues of hacker intercepting or transferring content signals, or making fake copyright.

For protection measures of information security for digital contents, one of techniques relates to securely booting an operation device. This technique uses a secure read only memory (ROM) chip, and stores executable code image(s) used for booting the device in the memory chip. This chip may confirm this code image with a unique key and control access rights of the code image(s). Thereby the operation device may complete building of the operating environment to subsequently execute the confirmed code image(s).

The other technology related to securely booting an operation device may use an network server to download a run time image file of an abbreviated version of an operating system and/or application(s) of the operation device to boot the operation device, and before the application loaded by each boot loader is allowed to be executed, checks the signature of the application(s). This technique executes an initial program loader (IPL), decompresses a boot program loader (BPL) to store in a random access memory (RAM), and executes the BPL to confirm whether the signature of a network programming loader (NPL) is correct. When the signature is confirmed, the BPL decompresses the NPL and stores in the RAM. This technique executes the NPL to initialize the operation device to a network connection to the network server, and downloads the executed image file of the abbreviated version of the operating system, and executes the operating system after the signature of this operating system is confirmed.

There are more and more products for obtaining digital contents through a variety of networked devices, such as multimedia platform Internet Protocol Television (IPTV) service, smart television stick, and smart television. The multimedia platform IPTV service transmits a variety of video and audio information to the set-top box through a two-way broadband network, and shows on the television. The smart television stick, through an input source having a high definition multimedia interface (HDMI), allows users to install specific applications through a smart phone to operate directly on watching television programs or receiving free network video and audio, to send these programs and/or the network video and audio to one or more liquid crystal display (LCD) televisions for viewing. The smart television has a networking function, which may couple with an input source of touchpad on a smart remote controller, and use specific applications provided by television manufacturer(s), to let users under account control, directly watch movie or other digital contents on the smart television through the network connection.

In the above technologies or products, or other similar technologies and/or products, the primary operating environment that service provider believes, and/or application services, etc. are stored in a storage loader, and loaded into an operation device or a smart device when using to ensure the completeness of the operating environment on a operation device or a smart device and building a secure operating environment. Wherein for the delivered information (such as operating system, application software, data, etc.), some technologies or products ensure the completeness of the operating environment on the operation device or the smart device and/or building the secure operating environment through such as completeness validation of encryption and decryption, some technologies or products verify the completeness of the operating environment and/or building the secure operating environment by using such as a security hardware module or a trusted platform module for performing validation of delivered data.

### SUMMARY

The exemplary embodiments of the present disclosure may provide a system and a method of building a primary system.

One exemplary embodiment relates to a system of building a primary system. The system may comprise an external storage module and a smart device. The external storage module stores a plurality of digital data. The plurality of digital data at least includes at least an external data of an operating system and/or an application operating system, and at least a resident data of the operating system and/or the application operating system. After the smart device boots, at least one first loader of the external storage module is loaded as a second loader of the smart device. The second loader loads the at least an external data and the at least a resident data respectively to integrate as an application operating environment image file, and activates the application operation environment image file to launch an application operating environment. Wherein data transmission for the plurality of digital data is provided between the external storage module and the smart device.

Another exemplary embodiment relates to a method of building a primary system, adapted to a smart device. The method may comprise: after having booted the smart device, loading at least one first loader of an external storage module as a second loader of the smart device; loading, by the second loader, at least an external data of an operating system and/or an application operating system in the external storage module and at least a resident data of the operating system and/or the application operating system respectively, and integrating the at least an external data and the at least a resident data to become an application operation environment image file; and activating the application operation environment image file to launch an application operating environment.

The foregoing and other features of the exemplary embodiments will become better understood from a careful reading of detailed description provided herein below with appropriate reference to the accompanying drawings.

### BRIEF DESCRIPTION OF THE DRAWINGS

FIG. 1 shows a system of building a primary system, according to an exemplary embodiment.

FIG. 2 shows illustrates elements of the external storage module and the smart device in FIG. 1, according to an exemplary embodiment.

FIG. 3 shows a first implementation at an initial stage of the system in FIG. 1, according to an exemplary embodiment.

FIG. 4 shows a second implementation at an initial stage of the system in FIG. 1, according to an exemplary embodiment.

FIG. 5 shows a third implementation at an initial stage of the system in FIG. 1, according to an exemplary embodiment.

FIG. 6 shows a fourth implementation at an initial stage of the system in FIG. 1, according to an exemplary embodiment.

FIG. 7 shows the implementation at an execution stage of the system of building a primary system, according to an exemplary embodiment.

FIG. 8A shows the second loader loads both external data and applications from the storage module, according to an exemplary embodiment.

FIG. 8B shows the second loader loads external data and resident data for integration, thereby generating an application operating system, and to load the application from the application operating system, according to an exemplary embodiment.

FIG. 9 shows a method of building a primary system, according to an exemplary embodiment.

FIG. 10 shows the operation at an initial stage and at an execution stage of the method in FIG. 9, according to an exemplary embodiment.

FIG. 11 shows the operation at an initial stage and at an execution stage of the method in FIG. 9, according to another exemplary embodiment.

FIG. 12 shows fullness check and design of a primary system, according to a first exemplary embodiment.

FIG. 13 shows fullness check and design of a primary system, according to a second exemplary embodiment.

FIG. 14A and FIG. 14B shows fullness check and design of a primary system, according to a third exemplary embodiment.

### DETAILED DESCRIPTION OF THE EXEMPLARY EMBODIMENTS

Below, exemplary embodiments will be described in detail with reference to accompanied drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

The disclosed exemplary embodiments may provide a technique of building a primary system, which may execute and build a primary system (including a primary operating system and/or an application environment) believed by a provider of service and/or digital contents through a smart device, to ensure the system's fullness. This technique may stack up to a variety of applications from the operating system that are primary, and may construct security infrastructure of application service such as digital content protection, data protection with bringing your own device (BYOD), so that all data of necessarily protected may legitimately be used in a primary operating environment. The smart device is a device with computing ability and network connectivity. According to exemplary embodiments of the disclosure, this technology separately loads image files of the operating system into a RAM to integrate, to form a complete application operating environment image file, and boot the application operating environment image file to build a clean and uncontaminated operating environment required by executable applications.

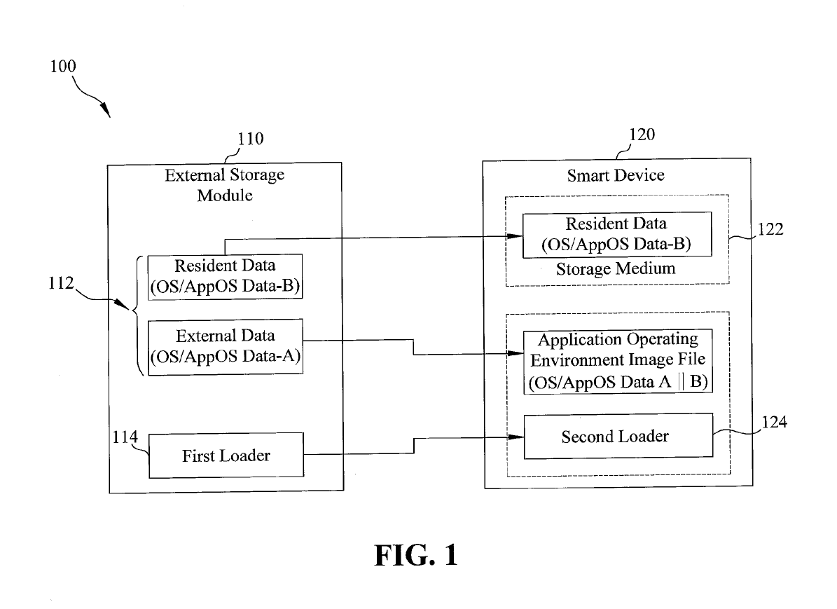

FIG. 1 shows a system of building a primary system, according to an exemplary embodiment. Refer to FIG. 1, the system of building a primary system 100 comprises an external storage module 110, and a smart device 120. In the external storage module 110, a plurality of digital data 112 are stored and data transmission of the plurality of digital data 112 is provided. The plurality of digital data 112 at least includes an external digital data (represented by OS/AppOS Data-A, and referred to external data) of at least one of operating systems and/or application operating systems, and resident digital data (represented by OS/AppOS Data-B and referred to resident data) of at least one of the operating systems and/or application of operating systems preloaded in the smart device 120. In the smart device 120, after the smart device 120 boots, at least one first loader 114 of the external storage module 110 is duplicated as a second loader 124 of the smart device 120. The second loader 124 loads the external data (OS/AppOS Data-A) and the resident data (OS/AppOS Data-B) respectively to integrate the external data (OS/AppOS Data-A) and the resident data (OS/AppOS Data-B) to become an application operating system image file (represented by OS/AppOS Data A∥B), and activates the application operation environment image file to launch an application operating environment.

The external storage module 110 may be constructed on at least one of a smart storage device and/or a network remote environment. The external storage module 110 may be implemented in many ways, such as but not limited to chip of flash memory, solid state disk (SSD), or other non-volatile medium that provides storage(s) with security management mechanism. The loaded resident data (OS/AppOS Data-B) may be stored in a storage medium 122 of the smart device 120. The storage medium 122 is such as, but not limited to non-volatile storage medium, hard disk, flash memory, solid-state disk (SSD), or other equipment that provides similar capabilities. The storage medium 122 may also provide an access capability.

The external data (OS/AppOS Data-A) is such as a part of operating system data of the operating system and/or the application operating system of a primary system. The resident data (OS/AppOS Data-B) is such as another part of operating system data of operating system and/or application operating system of primary system. The external data (OS/AppOS Data-A) and the resident data (OS/AppOS Data-B) are both un-executable digital data. For example, when booting the primary operating system is needed, the second loader 124 loads the resident data and the external data to a random access memory (RAM) of a smart device 120 and integrates the resident data and the external data, to form the application operating system image file, then loads and boots the application operating system image file, to become an operating system and/or an application operating system.

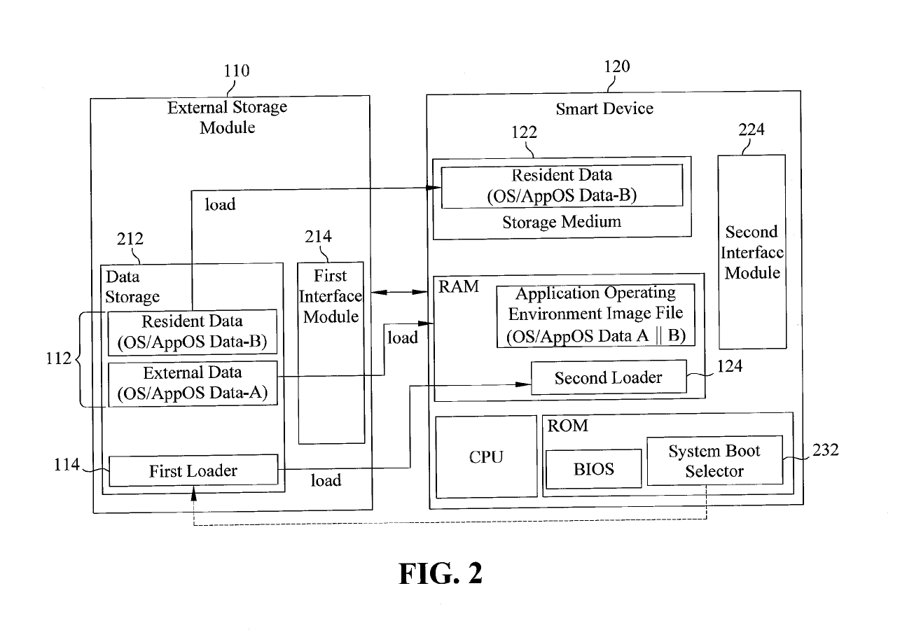

Data transmission of the plurality of digital data 112 is provided between the external storage module 110 and the smart device 120. As shown in the exemplar of FIG. 2, the plurality of digital data 112 stored in the external storage module 110 may be such as stored by a data storage 212, and transmitted between the data storage 212 and the external storage module 110 through a first interface module 214. The smart device 120 is a device having a computing capability, and at least includes such as a storage medium 122, a central processing unit (CPU), a random access memory (RAM), a read-only memory (ROM), and a second interface module 224. In the smart device 120, a basic input/output system (BIOS) or a system boot selector 232 of the read-only memory loads a first loader 114 of the external storage module 110 into the random access memory of the smart device 120 to become the second loader 124. The system boot selector 232 and the basic input/output system (BIOS) both actives the application operating environment. The system boot selector 232 may provide a selection function. In an operating environment of the smart device 120, after at least one first loader 114 is selected by using this selection function from a plurality of loaders, the at least one first loader 114 is loaded to be duplicated as a second loader 124 of the smart device 120. The second loader 124 loads the external data and the resident data to integrate as an application operating environment image file, and activates the application operation environment image file to launch an application operating environment.

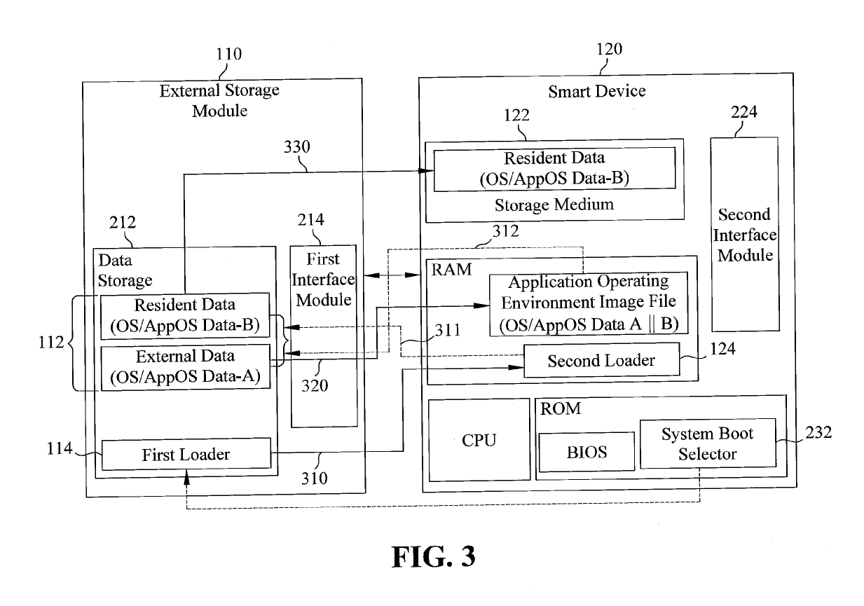

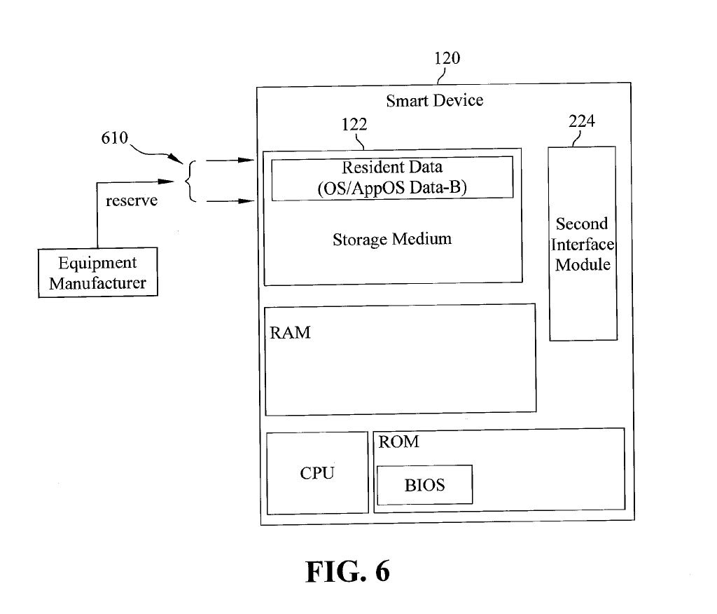

According to an exemplary embodiment, the system of building a primary system is implemented in two stages; one stage is the initial stage, another stage is the execution stage. In the initial stage, according to exemplary embodiments, the system checks whether the resident data (OS/AppOS Data-B) has been preloaded in the storage medium 122. When the resident data (OS/AppOS Data-B) has not been preloaded, the resident data (OS/AppOS Data-B) is loaded and stored in the storage medium 122 from the data storage 212 of the external storage module 110. In the execution stage, this system integrates the resident data and the external data to become an application operating system image file, and boots an application operating environment. According to the exemplary embodiments, the system may be implemented in a variety ways in the initial stage. The following FIG. 3˜FIG. 6 show four implementations in the initial stage of the system of building a primary system, wherein the solid line arrow represents the loading, the dashed line arrow represents driving.

Refer to FIG. 3, the first implementations in the initial stage of the system of building a primary system is as following. The system boot selector 232 drives the first loader 114 of the storage module 110, so that the first loader 114 is loaded into the smart device 120 and became a second loader 124 of the smart device 120 (solid line arrow 310); and when the smart device 120 detects no digital resident data (OS/AppOS Data-B) in the storage media 122, the second loader 124 loads the external data (OS/AppOS Data-A) and the resident data (OS/AppOS Data-B) of the external storage module 110, to form an application operating system image file (OS/AppOS Data A∥B) (dotted line arrow 312) to generate an executable operating environment. And after the storage medium 122 is identified, the resident data (OS/AppOS Data-B) is loaded into the storage medium 122 (solid line arrow 330), and the initial stage is completed.

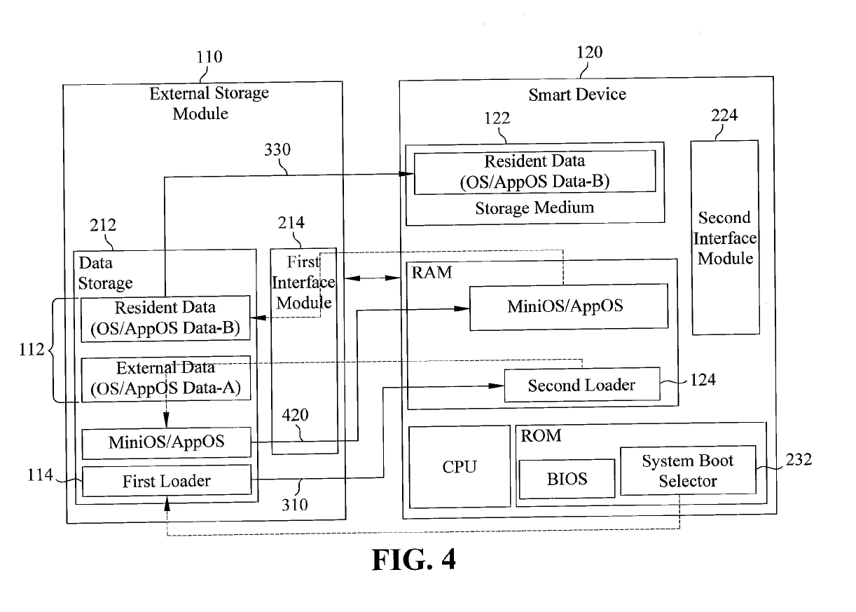

Refer to the exemplar in FIG. 4, the second implementations in the initial stage of the system of building a primary system is as following. The system boost selector 232 drives the first loader 114 of the storage module 110, so that the first loader 114 is duplicated as a second loader 124 of the smart device 120 (solid line arrow 310); in the external storage module 110, the system preloads and activates a mini operating system and/or an application operating system (MiniOS/AppOS). When the mini operating system and/or application operating system (MiniOS/AppOS) detects no digital resident data (OS/AppOS Data-B) of the storage medium 122, the second loader 124 loads the mini operating system and/or application operating system (MiniOS/AppOS) (solid line arrow 420). And after indentifying the storage medium 122, the resident data (OS/AppOS Data-B) is loaded into the storage medium 122 (solid line arrow 330), thereby completing the initial stage. This application operating system is an executable operating system combining the external data (OS/AppOS Data-A) with the resident data (OS/AppOS Data-B). The mini operating system is an executable operating system that a basic system operates.

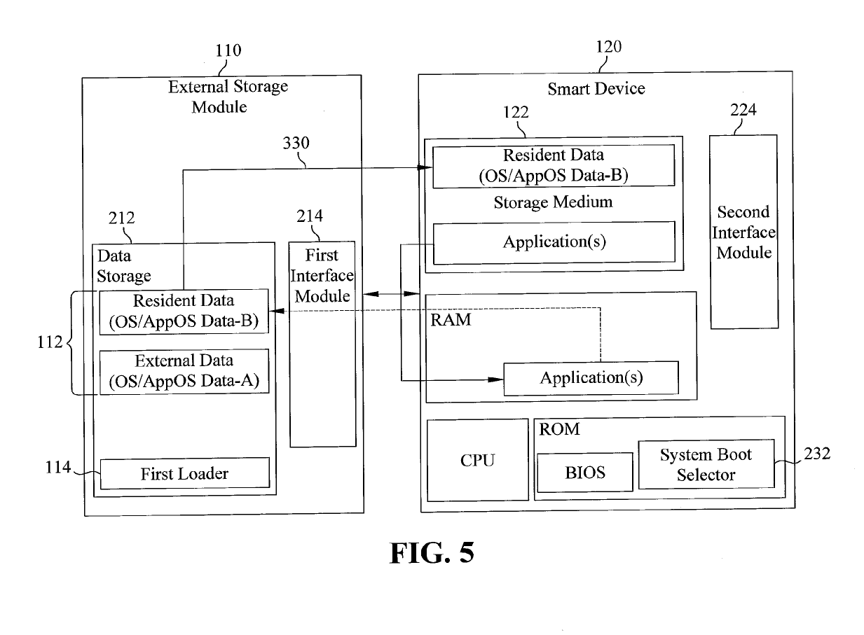

Refer to the exemplar of FIG. 5, the third implementations in the initial stage of the system of building a primary system is the following. The user boots an application (App) of an original operating environment on the smart device 120, loads the resident data (OS/AppOS Data-B) into the storage medium 122 (solid line arrow 330), and the initial stage is completed.

Refer to the exemplar of FIG. 6, the fourth implementations in the initial stage of the system of building a primary system is the following. A region 610 is reserved in the storage medium 122 in the smart device 120. When the smart device 120 detects no digital resident data in the storage media 122 (OS/AppOS Data-B), the resident data (OS/AppOS Data-B) is loaded into the region 610. For example, the equipment manufacturers may reserve a region in the storage medium 122 of their manufacturing equipment for storing the resident data (OS/AppOS Data-B).

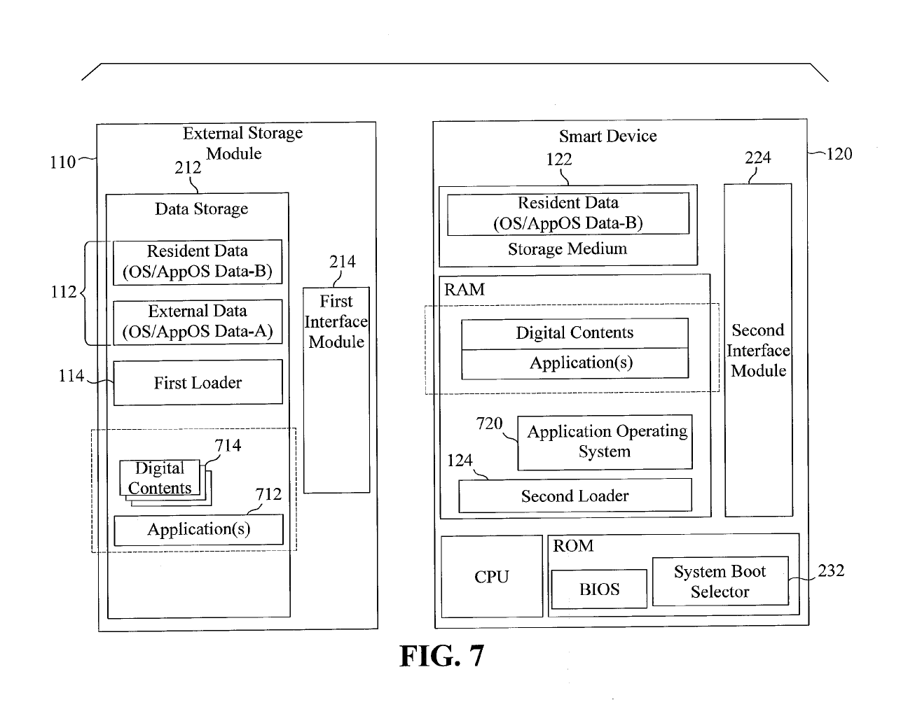

FIG. 7 shows an implementation in the execution stage of the system of building a primary system, according to an exemplary embodiment, wherein the solid line arrow represents loading, the dashed line arrow represents driving. Before entering the execute stage, the system of building a primary system has completed the initial stage, as mentioned above. At the time, the resident data (OS/AppOS Data-B) has been stored in the storage medium of the smart device 120. In the execution stage of FIG. 7, the second loader 124 of the smart device 120 loads the external data (OS/AppOS Data-A) and the resident data (OS/AppOS Data-B) into the random access memory, and integrates the resident data (OS/AppOS Data-B) and the external data (OS/AppOS Data-A) to form the application operating environment image file, and loads the application operating environment image file, then boots the application operating environment image file to become an executable operating system and/or executable application operating system 720.

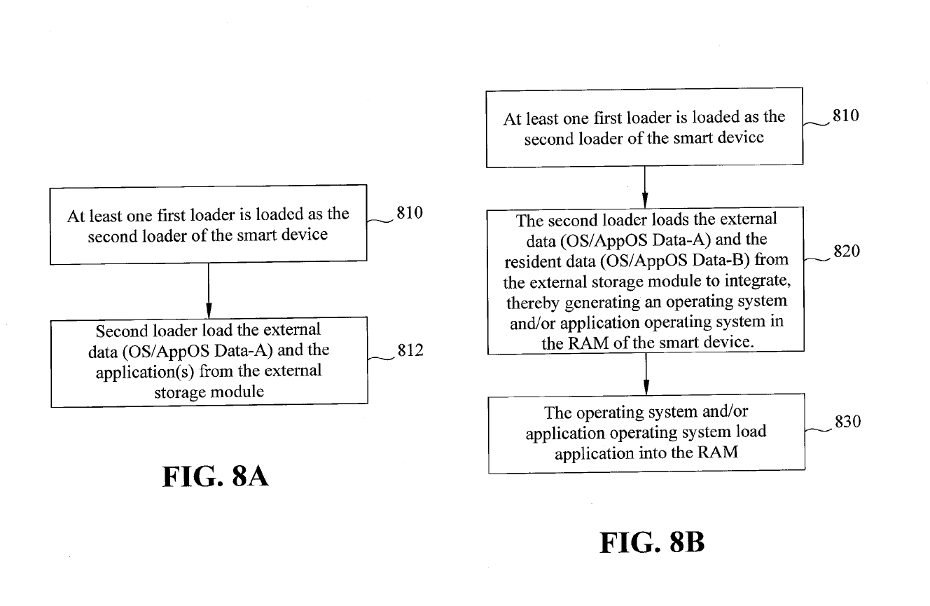

Accordingly, as shown in the exemplary embodiment of FIG. 8A, the at least one first loader 114 of the external storage module 110 is loaded as the second load device 124 of the smart device 120 (step 810), the second loader 124 may load the external data (OS/AppOS Data-A) and the application(s) 712 from the external storage module 110 (step 812). Or, according to an exemplary embodiment shown in FIG. 8B, the at least one first loader 114 of the storage module 110 is loaded as the second load device 124 of the smart device 120 (step 810), the second loader 124 loads the external data (OS/AppOS Data-A) and the resident data (OS/AppOS Data-B) from the external storage module 110 to integrate, thereby generating an operating system and/or application operating system 720 in the RAM of the smart device 120 (step 820). The operating system and/or application operating system 720 may load application 712 into the RAM (step 830).

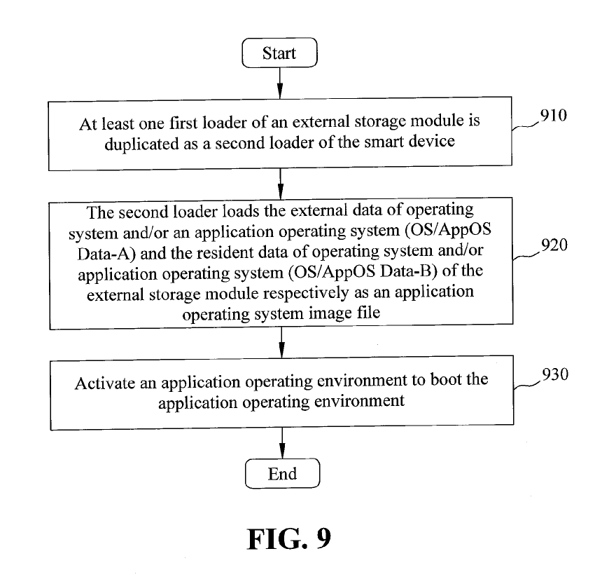

FIG. 9 shows a method of building a primary system, adapted to the smart device 120, according to an exemplary embodiment. Refer to the exemplar of FIG. 9, the method of building a primary system operates as following. When the smart device 120 is boots, at least one first loader of an external storage module is duplicated as a second loader of the smart device 120 (step 910); the second loader loads the external data of operating system and/or an application operating system (OS/AppOS Data-A) and the resident data of operating system and/or application operating system (OS/AppOS Data-B) of the external storage module respectively as an application operating system image file (step 920); and activates an application operating environment to boot the application operating environment (step 930).

As previously mentioned, the external storage module may be built in at least one of a smart storage device and a network remote environment, also may be implemented by using a variety of ways. The system of building a primary system is implemented with an initial stage and an execution stage. In the initial stage, as described previously in a variety of exemplary embodiment (such as FIG. 3˜FIG. 6), in the initial stage after the smart device 120 boots, the system checks whether the resident data has been preloaded in the storage medium of the smart device 120, and as described in the exemplary embodiment in the execution stage (e.g., FIG. 8B), the second loader 124 loads the external data (OS/AppOS Data-A) and the resident data (OS/AppOS Data-B) to integrate, thereby generating an application operating system, then loads application(s) from this application operating system. Or, as described in the exemplary embodiment of the initial stage (such as FIG. 8A), the second loader 124 may load the external data (OS/AppOS Data-A) and/or the application(s) from the external storage module 110.

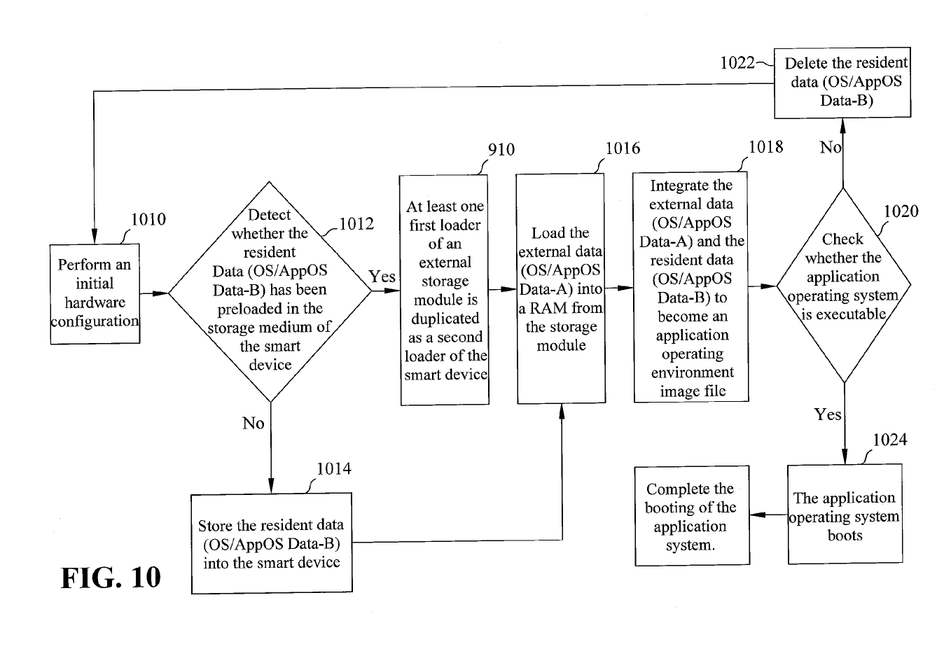

Accordingly, FIG. 10 shows the operation in the initial stage and in the execution stage of the method in FIG. 9, according to an exemplary embodiment. Refer to FIG. 10, in the initial stage, the method operates as following. An initial hardware configuration is performed (step 1010), which may include such as BIOS, boot selector setting. The method further detects whether the resident Data (OS/AppOS Data-B) has been preloaded in the storage medium of the smart device 120 (step 1012). When it detect no resident data (OS/AppOS Data-B) in the storage medium, stores the resident data (OS/AppOS Data-B) into the smart device 120 (step 1014), and then performs step 910. When the method detects the storage medium having the resident data (OS/AppOS Data-B), it performs step 910. Following step 910, the second loader 124 may also load the external data (OS/AppOS Data-A) into a RAM from the storage module 110 (step 1016), and then integrate the external data (OS/AppOS Data-A) and the resident data (OS/AppOS Data-B) to become an application operating environment image file (step 1018).

If the integration process is unsuccessful, which means an application operating system decompressed from the application operating system image file is not executable. The reason of unable to be executed is such as, but not limited to the image file has been tampered, or corrupted, or replaced, or decompressed unsuccessfully and so on. In the execution stage, the method checks whether the application operating system is executable (step 1020). When this application operating system is not executed, the method deletes the resident data (OS/AppOS Data-B) (step 1022) and returns to step 1010. When the application operating system is executable, the application operating system boots (step 1024), and complete the booting of the application system.

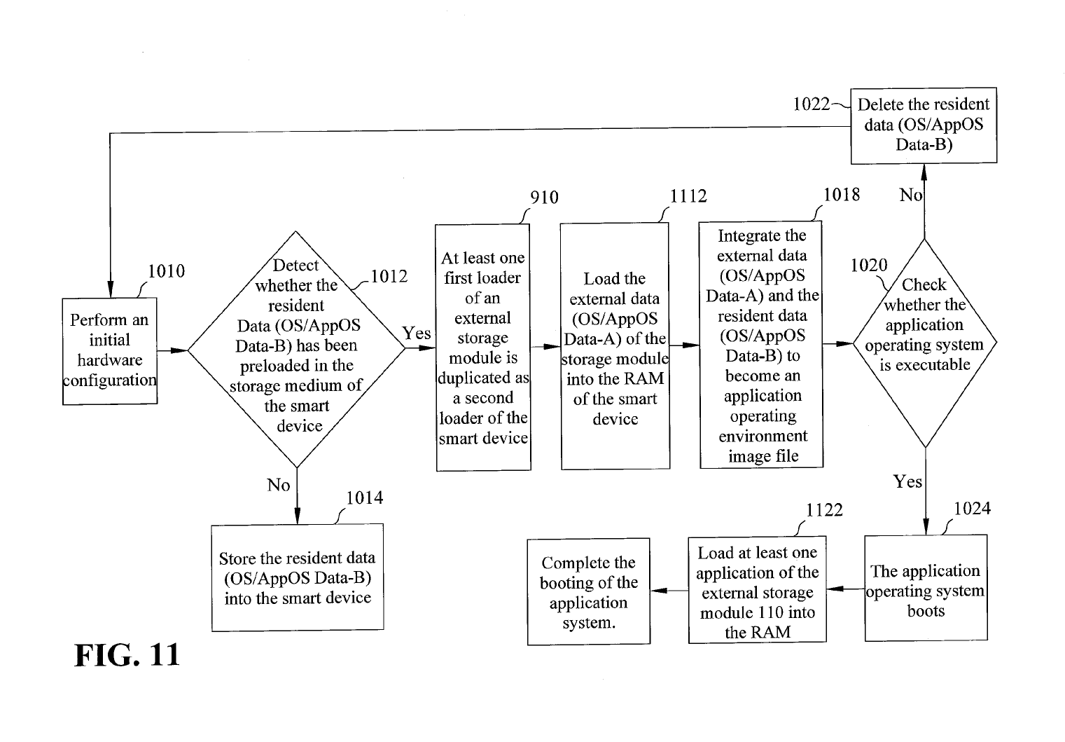

FIG. 11 shows the operation in the initial stage and in the execution stage of the method in FIG. 9, according to another exemplary embodiment. In FIG. 11, the operation before executing step 910 and the operation of executing step 910 are the same as the operation of the FIG. 10, not repeated here. Following step 910, the second loader 124 in FIG. 11 may load the external data (OS/AppOS Data-A) of the storage module 110 into the RAM of the smart device 120 (step 1112), and then integrate the external data (OS/AppOS Data-A) and the resident data (OS/AppOS Data-B) to become an application operating system image file (step 1018).

In the execution stage, the method executes step 1020. When the application operating system is not executable, the method executes step 1022 and returns to step 1010. When the application operating system is executable, the application operating system boots (step 1024) and loads at least one application of the external storage module 110 into the RAM (step 1122), and the booting of the application system is completed.

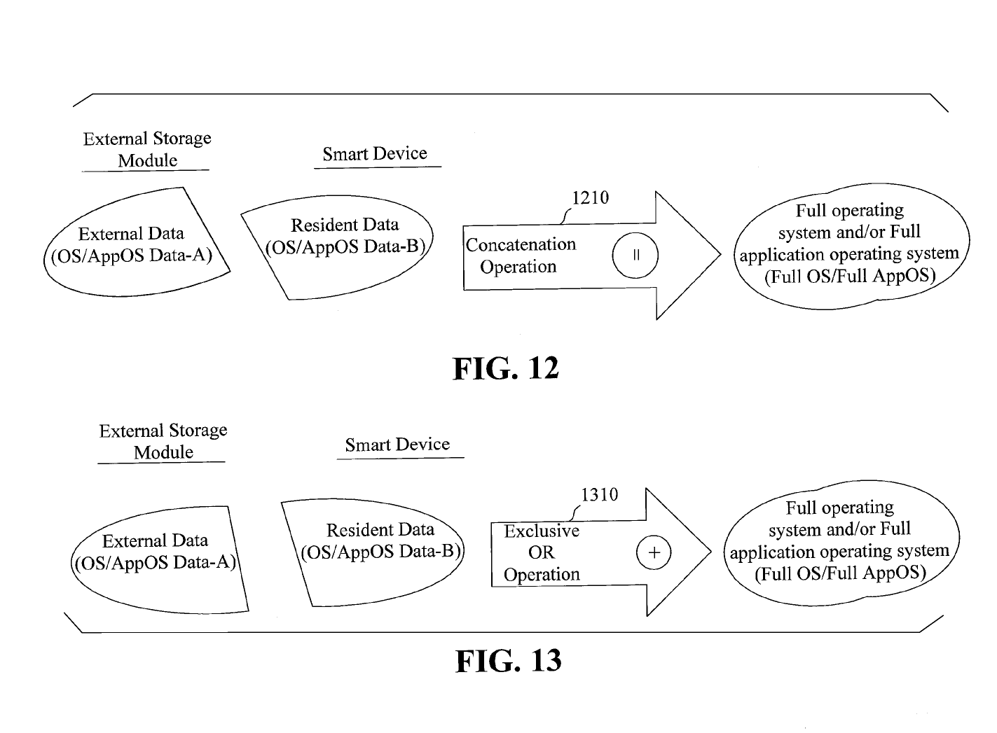

As mentioned before, the external data (OS/AppOS Data-A) is such as a partial operation system data of the operating system and/or the application operating system of a primary system, the resident data (OS/AppOS Data-B) is such as another partial operation system data of the system operating system and/or the application operating system of the primary system. The external data (OS/AppOS Data-A) and the resident Data (OS/AppOS Data-B) are not executable data. The following FIGS. 12-14 show several exemplary embodiments of integrity checking and design of a primary system respectively (including the segmentation process of the primary system and the restore process of the primary system).

In a first exemplary embodiment of FIG. 12, according to an embodiment of the integration method of building a primary system, the method uses a concatenation operation 1210, in the segmentation process, to divide the image file formed by compressing the primary system into the external data (OS/AppOS Data-A) and the resident data (OS/AppOS Data-B); and in the restore process, combines the external data (OS/AppOS Data-A) and the resident data (OS/AppOS Data-B). In the segmentation process of FIG. 12, the primary system is compressed into an image file with an image format, and then uses the concatenation operation 1210 to divide the image file into the external data (OS/AppOS Data-A) and the resident data (OS/AppOS Data-B) with a ratio. And, the external data (OS/AppOS Data-A) and the resident data (OS/AppOS Data-B) are placed in at least one of an external storage module and a network remote end. In the first initialization process, a loader places the resident data (OS/AppOS Data-B) in a smart device.

In the restore process of FIG. 12, the smart device has the resident data (OS/AppOS Data-B), then the loader transfers the external data (OS/AppOS Data-A) into the smart device from at least one of the external storage module and the network remote environment. Then the method uses the connection operation 1210 to combine the external data (OS/AppOS Data-A) and the resident Data (OS/AppOS Data-B), decompresses a full operating system (Full OS) and/or a full application operating system (Full AppOS). When the decompression process is completed successfully, which means the Full OS and/or the Full AppOS is completed. When the decompression process fails to be completed, which means that there is damaged or tampered of being uncompleted, and re-download or re-transfer is needed.

In a second exemplary embodiment of FIG. 13, according to an embodiment of method of building a primary system, the method uses an exclusive OR operation (XOR) 1310, in the segmentation process, to divide the image file or the tar file of the primary system into the external data (OS/AppOS Data-A) and the resident data (OS/AppOS Data-B); and in the restore process, the method combines the external data (OS/AppOS Data-A) and the resident data (OS/AppOS Data-B) with the exclusive OR operation. In the segmentation process of FIG. 13, the primary system is compressed into an image file with an image format or packed into one big file. And then the method uses the exclusive OR operation 1310 to divide the image file or the tar file into the external data (OS/AppOS Data-A) and the resident data (OS/AppOS Data-B). Following operations are the same as in FIG. 12, not repeated here. In the restore process of FIG. 13, the method uses the exclusive OR operation 1310 to combine the external data (OS/AppOS Data-A) and the resident data (OS/AppOS Data-B). Remaining operations are the same as in FIG. 12, and not be repeated here.

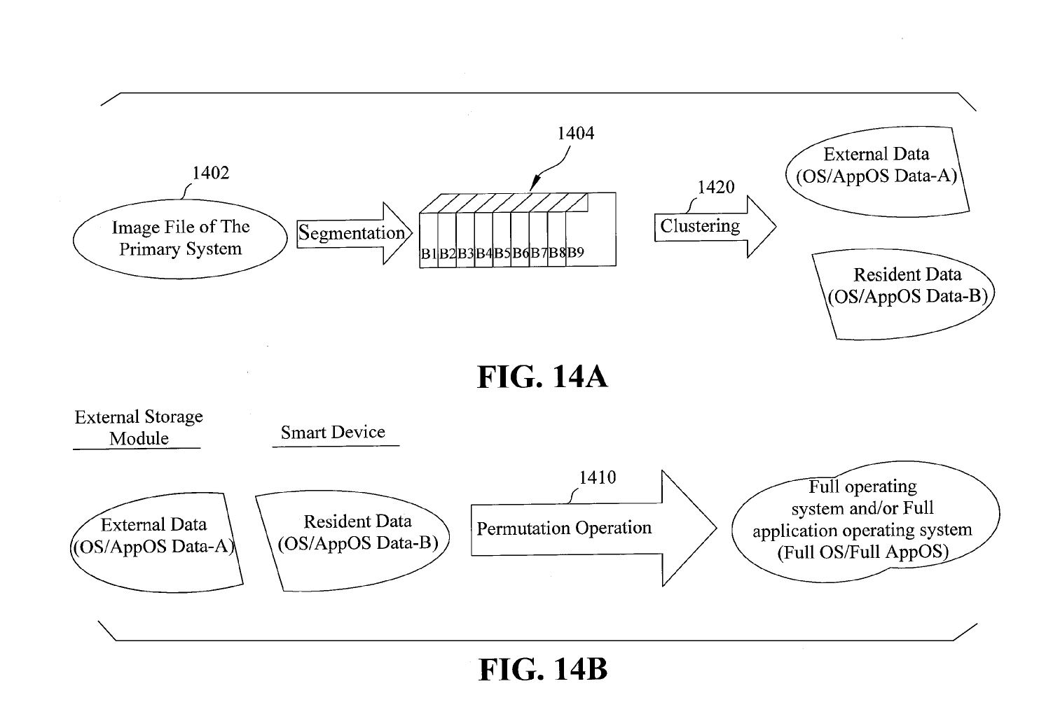

In a third exemplary embodiment of FIG. 14A and FIG. 14B, according to an embodiment of method of building a primary system, the method uses a permutation operation 1410, in the segmentation process, to divide the image file of the primary system, namely the external data (OS/AppOS Data-A) and the resident data (OS/AppOS Data-B) into two groups; and in the restore process, the method reversedly combines the external data (OS/AppOS Data-A) and the resident data (OS/AppOS Data-B) into a complete image file. In the segmentation process of FIG. 14A, the primary system is packaged into an image file 1402 with an image format, and then cuts the image file 1402 into a plurality of blocks 1404 of size, such as block B(1), . . . , B(9) and so on, each block having such as 128 bytes. The method then uses the permutation operation 1410 to cluster 1420 a plurality of blocks 1404 of the image file 1402 of the primary system into two groups, that are the external data (OS/AppOS Data-A) and the resident data (OS/AppOS Data-B). For example, the external data (OS/AppOS Data-A)=B(1)∥B(5)∥B(8)∥ . . . ∥B(2), and the resident data (OS/AppOS Data-B)=B(9)∥B(4)∥B(n)∥ . . . ∥B(3). In the restore process of FIG. 14B, the permutation operator is used to reversedly combine the external data (OS/AppOS Data-A) and the resident data (OS/AppOS Data-B) into a complete image file. Remaining operations are the same as in FIG. 12, and not be repeated here.

As shown in the operations mentioned in the exemplary embodiments of FIG. 12, FIG. 13 and FIG. 14, the method may use at least one of three operations, but not limited to the three operations of a concatenation operation, an exclusive OR operation, and a permutation operation. In a segmentation process, the method divides an image file formed by compressing the primary system into an external data and a resident data; and in a restore process, the method combines the external data and the resident data into the image file and then decompresses the image file to complete the process.

In summary, the exemplary embodiments provide a technique of building a primary system. This technique is coupled with a smart device to execute and build a primary system (including a primary operating system and/or an application environment), which may let providers of service and/or digital contents believe, to ensure the system's completeness. This technique may stacked up to a variety of applications from the operating system that are all primary, thereby, it may construct security infrastructure of application services such as digital content protection and digital data protection, so that all the data required to be protected are legally used in the primary operating environment. According to the exemplary embodiments, this technology dividedly loads an image file of the operating system into a RAM and integrates again, to form a complete application operating system image file, and boots the application operating system image file to build an uncontaminated computing environment required by executable applications.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A system of building a primary system, comprising:
an external storage module for storing a plurality of digital data and providing data transmission of said plurality of digital data, wherein said plurality of digital data at least includes at least an external data of an operating system and/or an application operating system, and at least a resident data of said operating system and/or said application operating system; and
a smart device, wherein after said smart device boots, at least one first loader of said external storage module is loaded as a second loader of said smart device, and said second loader loads the at least an external data and the at least a resident data respectively to integrate as an application operating environment image file, and activates the application operation environment image file to launch an application operating environment;
wherein said data transmission of said plurality of digital data is provided between said external storage module and said smart device.

2. The system as claimed in claim 1, wherein said smart device is a device having a computing capability, and at least includes a storage medium, a central processing unit, a random access memory, and a read-only memory, and said storage medium provides an access capability.

3. The system as claimed in claim 2, wherein a basic input output system of said read-only memory or a boot selector loads said first loader of said external storage module into said random access memory to become said second loader.

4. The system as claimed in claim 2, wherein in an initial stage, said system sets and stores at least a digital data of said plurality of digital data, while in an execution stage, boots said application operating environment.

5. The system as claimed in claim 4, wherein when said smart device detects no digital data of said at least a resident data in said storage medium, the second loader integrates said at least an external data and said at least a resident data in said external storage module, thereby generating an executable operating environment, and after indentifying said storage medium, the second loader loads said at least a resident data into said storage medium and completes said initial stage.

6. The system as claimed in claim 4, wherein said system preloads a mini operating system and/or an application operating system in said smart device, and when said smart device detects no digital data of said at least a resident data in said storage medium, said second loader loads and activates said mini operating system and/or said application operating system, and after indentifying said storage medium, said second loader loads said at least a resident data into said storage medium and completes said initial stage.

7. The system as claimed in claim 6, wherein said application operating system is an executable application operating system combining said at least an external data with said at least a resident data, and said mini operating system is an executable operating system that a basic system operates.

8. The system as claimed in claim 4, wherein a region is reserved on said storage medium of said smart device, when said smart device detects no digital data of said at least a resident data in said storage medium, said smart device loads said resident data into said region.

9. The system as claimed in claim 4, wherein in said execution stage, the second loader integrates said resident data and said loaded at least an external data, to form said application operating environment image file, then boots said application operating environment to become an executable operating system and/or an executable application operating system.

10. The system as claimed in claim 1, wherein said external storage module is constructed on one of said smart storage device and/or a network remote environment.

11. A method of building an primary system, adapted to an smart device, said method comprising:
after having booted the smart device, loading at least one first loader of an external storage module as a second loader of the smart device;
loading, by the second loader, at least an external data of an operating system and/or an application operating system in the external storage module and at least a resident data of the operating system and/or the application operating system respectively, and integrating the at least an external data and the at least a resident data to become an application operation environment image file; and
activating the application operation environment image file to launch an application operating environment.

12. The method as claimed in claim 11, wherein said external storage module is constructed on one of said smart storage device and/or a network remote environment.

13. The method as claimed in claim 11, wherein in an initial stage, said method sets and stores at least a digital data of said plurality of digital data, while in an execution stage, boots said application operating environment.

14. The method as claimed in claim 13, wherein said method further includes:
performing an initial hardware configuration;
detecting whether the at least a resident data has been preloaded in a storage medium of said smart device; and
loading, by said second loader, said at least an external data and said at least a resident data from said external storage module.

15. The method as claimed in claim 14, wherein said method further includes:
booting said application operation environment to become an executable operating system and/or application operating system.

16. The method as claimed in claim 13, wherein said method further includes:
in said initial stage, loading, by said second loader, said at least an external data and said at least a resident data from said external storage module; and
in said execution stage, integrating said at least an external data and said at least a resident data, thereby generating said operating system and/or application operating system.

17. The method as claimed in claim 13, wherein said at least an external data is a partial operation system data of the operating system and/or the application operating system of said primary system, and said at least a resident data is another partial operation system data of the operating system and/or the application operating system of said primary system.

18. The method as claimed in claim 17, wherein said method uses at least one operation of three operations of a concatenation operation, an exclusive OR operation, and a permutation operation, and in a segmentation process divides an image file formed by compressing said primary system into said at least an external data and said at least a resident data, and in a restore process combines said at least an external data and said at least a resident data into said image file and decompresses said image file.

19. The method as claimed in claim 17, wherein said at least an external data and said at least a resident data are un-executable digital data.
